(19) United States
(12) Patent Application Publication
(10) Pub. No.: US 2005/0215278 A1
(43) Pub. Date: Sep. 29, 2005

(54) Mobile device with image scanning capability

(76) Inventors: Yuen Khim Joseph Liow, Singapore (SG); Sin Guan Eng, Selangor (MY)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 10/808,794

(22) Filed: Mar. 24, 2004

(51) Int. Cl. G06K 9/22

(52) U.S. Cl. 455/550.1

(57) ABSTRACT

A mobile device comprising a keypad for entry of instructions, a display, a sensor, a memory, a processor for controlling the keypad, the display, the sensor and the memory; and a character recognition engine. The sensor is for obtaining image data of at least one image. The character recognition engine is for processing the image data. The memory is for storage of at least one of the processed image data and the image data.

### FIELD OF THE INVENTION

The present invention relates to a mobile device with image scanning capability and refers particularly, though not exclusively, to such a device with character recognition capability.

### DEFINITION

Throughout this specification a reference to a mobile device is to be taken as including a reference to a portable digital assistant, mobile telephone, cellular telephone, personal organiser, or two or more of them in the one device, including such devices with telecommunications capabilities.

### BACKGROUND TO THE INVENTION

Present technology for scanning text and images typically consists of a handheld scanner or a flatbed scanner. To transmit the scanned information, the device needs to be connected to a computer, and the processed data downloaded to the computer. It can then be sent. With a mobile device, the scanned information cannot be transmitted to the mobile device directly. The process of scanning and transmitting the information to the mobile device involves coupling several devices, and becomes quite awkward or inconvenient.

It may be quite difficult to input large amounts of information into present mobile devices. Generally, data can only be input using an attached keypad, or by downloading from a computer.

At present, mobile devices are fast becoming standard and inexpensive devices. Therefore, by integrating image and scanning functions, users may be provided with a direct and efficient method of information gathering and transmission.

### SUMMARY OF THE INVENTION

In accordance with a first preferred aspect there is provided a mobile device comprising a keypad for entry of instructions; a display; a sensor; a memory; a processor for controlling the keypad, the display, the sensor and the memory; and a character recognition engine. The sensor is for obtaining image data of at least one image. The character recognition engine is for processing the image data. The memory is for storage of at least one of the processed image data and the image data.

The image data may be processed by the character recognition engine and may be displayed on the display. The character recognition engine may comprise one or more of: an image recognition application, a handwriting recognition application, a printed character recognition application, and a hand-written character recognition application.

There may be further provided a card reader engine for recognising, sorting and categorising the processed image data. The sorting and categorising may be by at least one field selected from: family name, at least one given name, company name, company address, telephone number, email account, nature of business, position in company, and title.

The memory may be built-in on removable.

The sensor may be mounted on a wand operatively connected and releasably attached to the mobile device. The wand may be releasably receivable in a chamber in the mobile device. Alternatively, the sensor may be built-in to the mobile device.

In another aspect there is provided a method for capturing data by using a mobile device, the method comprising:
(a) activating a sensor forming a part of the mobile device;
(b) using the sensor to scan at least one image to obtain image data;
(c) processing the image data in a processor forming a part of the mobile device;
(d) saving the processed image data in a memory in the mobile device; and
(e) transmitting the processed image data from the mobile device.

The activating step (a) may comprise:
(i) activating the sensor as a result of a received instruction;
(ii) activating an indicator to indicate the activation of the sensor;
(iii) moving the sensor to be above the at least one image;
(iv) transferring the sensor to a data-capturing mode; and
(v) altering the activation of the indicator to indicate the sensor is in the data- capturing mode.

The processing step (c) may comprise processing the image data in at least one of: a character recognition engine, an image recognition engine, and a card reader engine. The character recognition engine may include one or more of: an image recognition application, a handwriting recognition application, a printed character recognition application, and a hand-written character recognition application.

The card reader engine may sort and categorise the image data by at least one field selected from: family name, at least one given name, company name, company address, telephone number, email account, nature of business, position in company, and title.

The transmitting step (e) may comprise transmitting the processed image data using at least one of: wireless transmission, SMS, MMS, GSM a telephone system, or by a cable for connecting the mobile device to at least one computer.

In a final aspect there is provided a computer usable medium comprising a computer program code that is configured to cause at least one processor to execute one or more functions to perform the method described above.

### BRIEF DESCRIPTION OF THE DRAWINGS

In order that the invention may be better understood and readily put into practical effect, there shall now be described by way of non-limitative example only preferred embodiments of the present invention, the description being with reference to the accompanying illustrative drawings in which:

FIG. 1 is a front view of a first embodiment of the mobile device;

FIG. 2 is an underneath view of the mobile device of FIG. 1;

FIG. 3 is a front view of a dialog box of the first embodiment of FIGS. 1 and 2;

FIG. 4 is a side view of the first embodiment in use;

FIG. 5 is a side view of the first embodiment in a second use;

FIG. 6 illustrates the connection of the first embodiment to a computer;

FIG. 7 is a block diagram of the first embodiment of FIGS. 1 to 6;

FIG. 8 is a front view of a second embodiment;

FIG. 9 is a side view of the embodiment of FIG. 8;

FIG. 10 is a front view of a third embodiment in partial section;

FIG. 11 is a flow chart of the operation of the devices of FIGS. 1 to 9; and

FIG. 12 is a flow chart for the operation of a card reader.

### DETAILED DESCRIPTION OF THE PREFERRED EMBODIMENTS

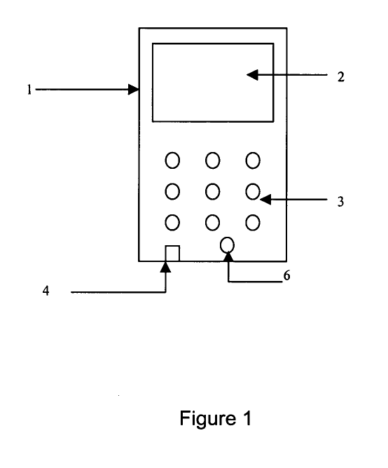

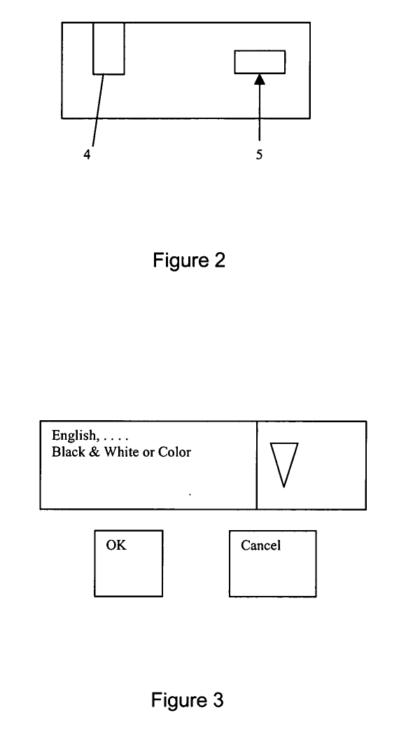

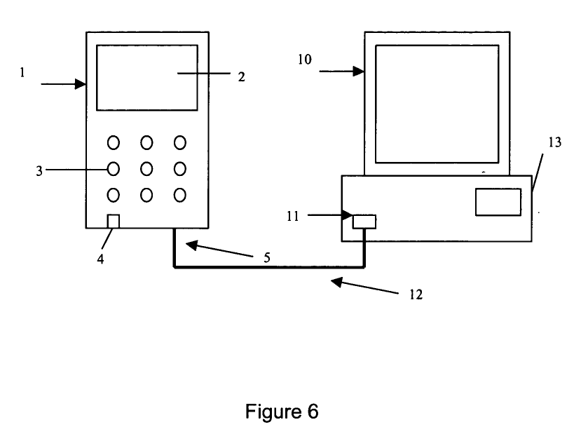

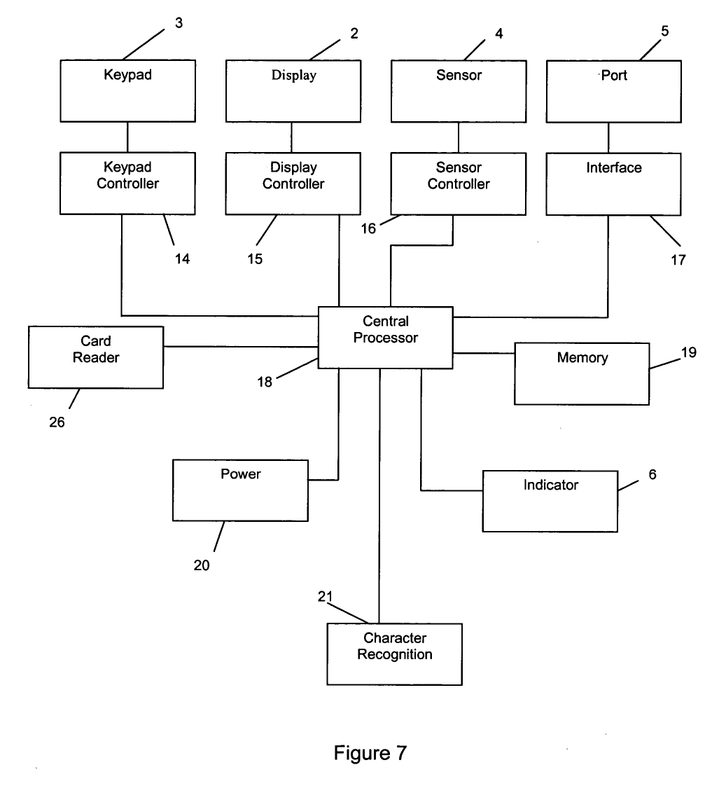

To first refer to FIGS. 1 to 7, there is shown a mobile device 1, in this case a mobile telephone, having a display 2 and a keypad 3. Also included is an image sensor 4 and an indicator light, such as an LED, for indicating the operational status of image sensor 4. A port 5 is provided to enable the mobile device 1 to be operatively connected to other devices such as, for example, computer 13 (FIG. 6). Although, port 5 is shown as being rectangular, it may be of any suitable shape, size or nature. Preferably it is a USB port, or an IEEE 1384 port.

The display 2, keypad 3, scanner 4 and port 5 all have a required controller/interface 14, 15, 16 and 17 respectively. A central processor or processors 18 controls the overall operation. A memory 19 is also provided as is a power source 20. Memory 19 may be built-in or may be removable. If removable it may be, for example, a thumb drive, a micro drive, a flash card, a multi-media card, and so forth. A character recognition engine 21 is also provided. The character recognition engine 21 may have one or more applications for image recognition and character recognition including handwriting, printed character, and hand-written characters.

As is shown in FIG. 6, the mobile device 1 may be able to be operatively connected to a computer 13 having a display 10. Computer 13 may be a server, personal computer, desktop computer, laptop computer, notebook computer, tablet computer, or personal digital assistant. Connection may be by cable 12 operatively connected to port 5, and to a port 11 in computer 13. Alternatively, the connection may be by a wireless connection using any suitable wireless connectivity system such as, for example, “Bluetooth”; or by a standard telephone system such as, for example, GSM.

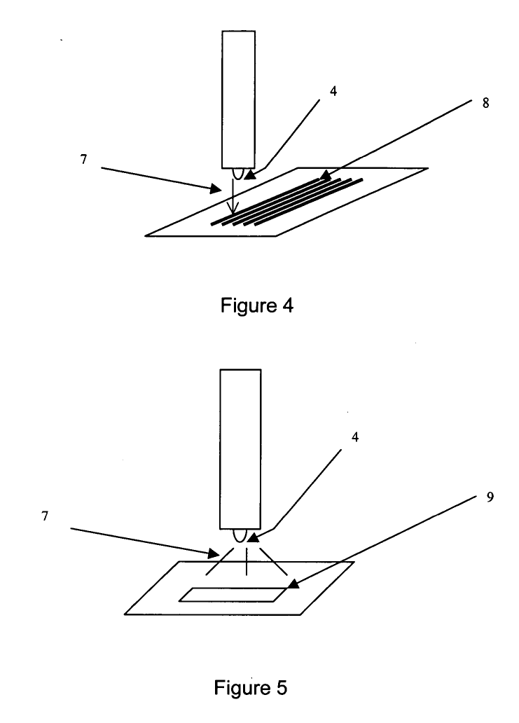

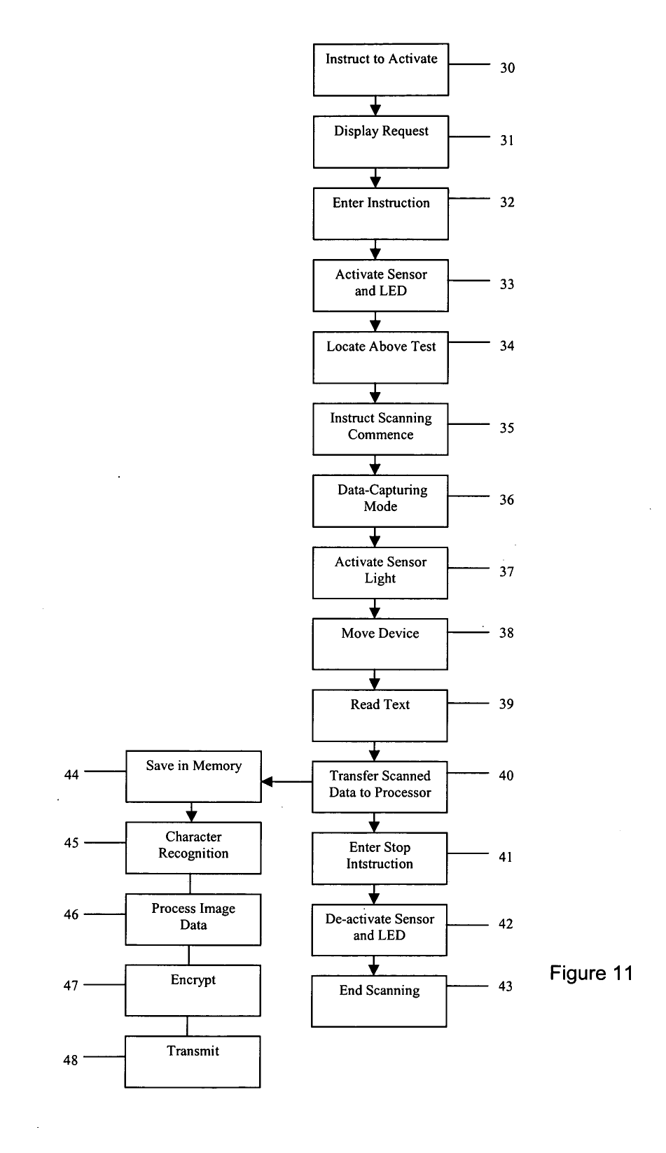

FIGS. 3 and 4 and the flow chart of FIG. 11 show a first image-capturing situation. Upon keypad being used to instruct processor to activate the sensor 4 (30), there is displayed (31) on display 2 a request for input of language, and colour (FIG. 3). Upon the necessary instructions being entered (32) (separately, or in combination) the sensor 4 is activated (33). At the same time, LED 6 is illuminated to indicate to a user that sensor 4 has been activated. Additionally or alternatively, display 2 may be used to provide an indication of the status of scanner 4.

The sensor 4 is then located (34) immediately above the beginning of the text to be scanned (FIG. 4). An instruction (35) to commence scanning is then entered using keypad 3. Processor 18 passes that instruction to sensor controller 16. That, in turn, causes sensor 4 to enter a data-capturing mode (36). The sensor 4 then emits a light 7 in the usual manner (37). The light 7 illuminates and is used to scan the text 8. The mobile device 1 is then moved linearly (left-to-right or right-to-left) (38) and the light 7 is maintained substantially in alignment with the centre of the text 8. The image sensor 4 will therefore read the scanned text and transfer it to the central processor 18 (40). During the scanning, the LED 6 may blink at a predetermined rate to indicate that scanning, and data capturing, is occurring.

At the completion of scanning, a further instruction is entered (41) by use of keypad 3 to cease operation of the sensor 4. The processor 18 passes that instruction to sensor controller 16 and the sensor 4 is de-activated (42). The LED 6 is also turned off by processor 18. The immediate data capturing the ends (43).

An alternative image-capturing process is illustrated in FIG. 5. Here, the mobile device 1 is placed a greater distance from the image 9 to be scanned. This is more relevant for larger, single images such as, for example, a drawing, photograph, table, chart, graph, larger characters, and so forth. All process steps are the same—except that mobile device 1 is held stationary while data capture takes place.

When central processor 18 receives the image data, it saves the data in memory 19 (44). If required, the image data is processed by a character and/or image recognition engine 21 (45) to format the image data as required or desired. For example, the text 8 may be processed (46) to convert the image data to text suitable for printing, transmission and/or display on the display 2. Also, the image data for image 9 may be processed according to different file standards or categories and/or resized or compressed for display on display 2 and/or printing or transmission. Processor 18 may include an encoder for encrypting data (48) before transmission.

Memory 19 may also be used to store the data after processing by recognition engine 21.

The mobile device 1 is preferably able to transmit the data (48) to other devices in a number of ways: by wireless transmission by, for example, SMS or MMS protocols; by use of a cable 12 as is shown in FIG. 6; or by use of a memory module or device such as, for example, a Flash card or a thumbstick, preferably using port 5.

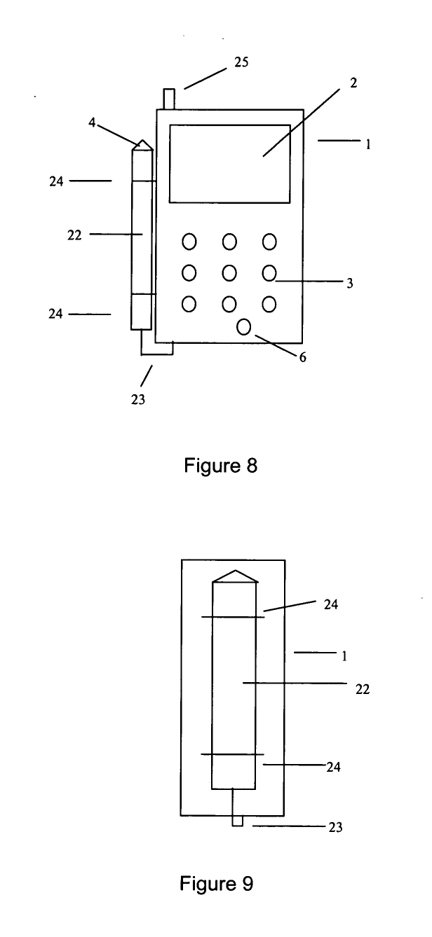

FIGS. 8 and 9 show a second embodiment. Here, the sensor 4 is mounted to one end of a wand 22 connected to mobile device 1 by a cable 23, or wirelessly. The wand 23 is releasably attachable to mobile device 1 by clips 24. To use the sensor 4, the wand 22 is released from clips 24 and used as is described above. Wireless communication may be by a wireless communication system within wand 23, and that communicates with an antenna 25 of the mobile device 1.

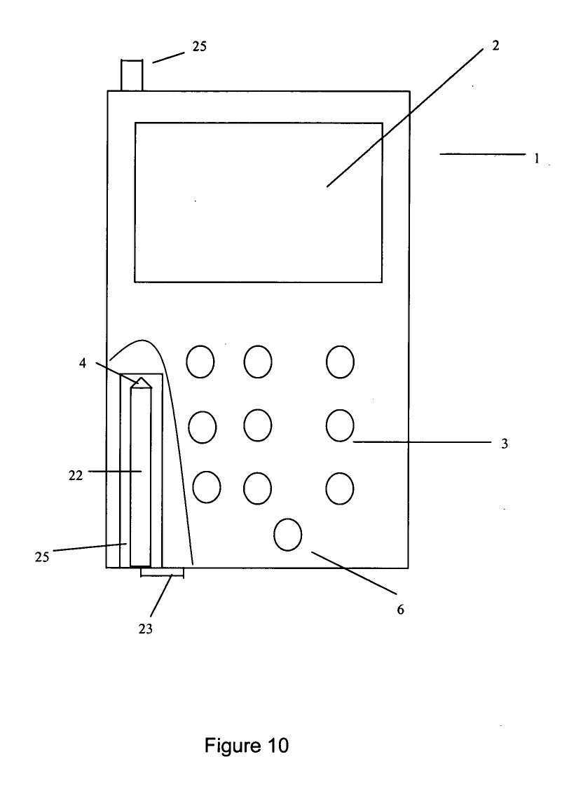

FIG. 10 shows a third embodiment where wand 22 is releasably receivable in a recess or chamber 25 in mobile device 1. Again, the wand 22 is usable as is described above.

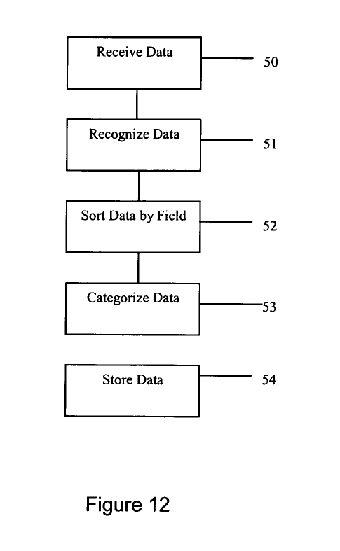

Processor 18 may further include a card reader engine 26 so that the sensor 4 may be used to scan data from business cards, name cards or the like. The data may be processed by engine 26 to sort and categorise the data by a predetermined number of fields including, but not limited to, family name, given name(s), company name, company address, telephone number, email account, nature of business, position in company, title, and so forth. The actual fields used may be preset, may be user determined, or may have some preset and some user determined. In this way the data can be captured by sensor 4, rather than being entered by keypad 3. The process flow of the card reader 26 is as shown in FIG. 12 and includes receiving the captured data (50), recognising the data (51), sort the data according to the fields as described above, and categorise the data (53). The data can then be stored in memory 19 (54).

Furthermore, processor 18 and/or character recognition engine 21 may include handwriting recognition application so that if text 8 or image 9 is hand-written, it may be read and recognised.

The present invention also includes a computer usable medium comprising a computer program code that is configured to cause at least one processor to execute one or more functions to perform the method described above.

Whilst there has been described in the foregoing description preferred embodiments of the present invention, it will be understood by those skilled in the technology concerned that many variations in details of design, construction and operation may be made without departing from the present invention.

1. A mobile device comprising:
(a) a keypad for entry of instructions;
(b) a display;
(c) a sensor;
(d) a memory;
(e) a processor for controlling the keypad, the display, the sensor and the memory; and
(f) a character recognition engine;
wherein
(g) the sensor is for obtaining image data of at least one image, the character recognition engine is for processing the image data, and the memory is for storage of at least one of the processed image data and the image data.

2. A mobile device as claimed in claim 1, wherein the image data is processed by the character recognition engine and is displayed on the display.

3. A mobile device as claimed in claim 1, wherein the character recognition engine comprises at least one selected from the group consisting of: an image recognition application, a handwriting recognition application, a printed character recognition application, and a hand-written character recognition application.

4. A mobile device as claimed in claim 1, wherein the memory is one of: built-in, and removable.

5. A mobile devices claimed in claim 1, further comprising a card reader engine for recognising, sorting and categorising the processed image data.

6. A mobile device as claimed in claim 1, wherein the sorting and categorising is by at least one field selected from the group consisting of: family name, at least one given name, company name, company address, telephone number, email account, nature of business, position in company, and title.

7. A mobile device as claimed in claim 1, wherein the sensor is mounted on a wherein the sensor is mounted on a wand operatively connected and releasably attached to the mobile device.

8. A mobile device as claimed in claim 1, wherein the sensor is built-in to the mobile device.

9. A mobile device as claimed in claim 7, wherein the wand is releasably receivable in a chamber in the mobile device.

10. A method for capturing data by using a mobile device, the method comprising:
(a) activating a sensor forming a part of the mobile device;
(b) using the sensor to scan at least one image to obtain image data;
(c) processing the image data in a processor forming a part of the mobile device;
(d) saving the processed image data in a memory in the mobile device; and
(e) transmitting the processed image data from the mobile device.

11. A method as claimed in claim 10, wherein the activating step (a) comprises:
(a) activating the sensor as a result of a received instruction;
(b) activating an indicator to indicate the activation of the sensor;
(c) moving the sensor to be above the at least one image;
(d) transferring the sensor to a data-capturing mode; and
(e) altering the activation of the indicator to indicate the sensor is in the data-capturing mode.

12. A method as claimed in claim 10, wherein the processing step (c) comprises: processing the image data in at least one of: a character recognition engine, an image recognition engine, and a card reader engine.

13. A method as claimed in claim 10, wherein the character recognition engine includes at least one of: a handwriting recognition application, a printed character recognition application, and a hand-written character application.

14. A method as claimed in claim 11, wherein the card reader engine sorts and categorises the image data by at least one field selected from the group consisting of: family name, at least one given name, company name, company address, telephone number, email account, nature of business, position in company, and title.

15. A method as claimed in claim 10, wherein the transmitting step (e) comprises transmitting the processed image data using at least one of: wireless transmission, SMS, MMS, GSM, a telephone system, or by a cable for connecting the mobile device to at least one computer.

16. Computer usable medium comprising a computer program code that is configured to cause at least one processor to execute one or more functions to perform the method of claim 10.
